(19) United States
(12) Patent Application Publication
(10) Pub. No.: US 2007/0123351 A1
(43) Pub. Date: May 31, 2007

(54) GAME CONTROL DEVICE

(75) Inventors: Chiu-Hao Cheng, TAIPEI (TW); Ming-Gwo Cheng, TAIPEI (TW)

Correspondence Address: ZEROPLUS TECHNOLOGY CO., LTD., 2F-4, NO. 184, SEC. 4, CHUNG HSIAO EAST ROAD, TAIPEI, TW

(73) Assignee: ZEROPLUS TECHNOLOGY CO., LTD., Chungho City, Taipei Hsien (TW)

(21) Appl. No.: 11/164,598

(22) Filed: Nov. 30, 2005

(51) Int. Cl. A63F 13/00

(52) U.S. Cl. 463/38

(57) ABSTRACT

A game control device for use with a game machine main unit having an audio output is disclosed to include a transmission interface, an index input device, a vibrator, a power supply device, a display device, and a microcontroller, which receives a status signal from the transmission interface, the index input device, the vibrator, the power supply device and the game machine main unit and converts the status signal into a corresponding status data for causing the display device to display each status data in a respective device picture corresponding to the transmission interface, the index input device, the vibrator, the power supply device and the game machine main unit.

### BACKGROUND OF THE INVENTION

1. Field of the Invention

The present invention relates to game machines and more particularly, to a game control device, which displays the operation status of the transmission interface, the index input device, the vibrator, the power supply and the game machine main unit.

2. Description of the Related Art

Following the development of different video game machines, a variety of video game programs have been created. A game machine is generally used with a game control device, which may be made in the form of a game pad, joystick or steering wheel.

In order to enhance the controllability, various advanced game pads are created. From the early design with continuous shooting function to the latest design with recording function, different game pads have been developed for use with different video game machines. FIG. 6 shows a sophisticated game pad with a LCD panel. As illustrated, the game pad A has a LCD panel A1 for showing the operation status of the game pad A or the capacity of the memory.

In the aforesaid game pad A, the LCD panel A1 is designed to show a fixed arrangement. The game pad A does not allow the user to change the display arrangement of the LCD panel A1. Further, because the game pad A has a limited size, the size of the LCD panel A1 is also limited. If the LCD panel A1 is set to display a number of status of the game pad A, a display screen of the LCD panel A1 must be divided into multiple small display zones for the display of different status of the game pad A. In this case, the user may be difficult to see each item displayed on each display zone. On the contrary, when reducing the number of display zones, the number of status of the game pad A to be displayed on the display screen of the LCD panel A1 is relatively reduced, and the LCD panel A1 will be unable to show all status of the game pad A.

Therefore, it is desirable to provide a game control device that eliminates the aforesaid problem.

### SUMMARY OF THE INVENTION

The present invention has been accomplished under the circumstances in view. It is the main object of the present invention to provide a game control device, which has a display device controllable to display the device picture of the transmission interface, index input device, vibrator, power supply unit or game machine main unit and the operation status of the respective device in the selected device picture. It is another object of the present invention to provide a game control device, which enables the user to select the device picture of the transmission interface, the index input device, the vibrator, the power supply unit or the game machine main unit for display on the display device by means of operating the index input device.

To achieve these and other objects of the present invention, the game control device is set for use with a game machine main unit, comprising a transmission interface for data transmission between the game control device and the game machine main unit, an index input device for providing a control signal, a vibrator for producing a vibration, a power supply device for providing the game control device with the necessary working power, display means for displaying data, and a microcontroller electrically coupled to the transmission interface, the index input device, the vibrator, the power supply device and the display means, wherein the transmission interface, the index input device, the vibrator and the power supply device respectively produce a respective status signal during operation; the microcontroller receives the status signal from the transmission interface, the index input device, the vibrator, the power supply device and the game machine main unit, converts the status signal into a corresponding status data, and sends the status data to the display means; the display means is controlled by the microprocessor to display each status data received from the microprocessor in a respective device picture corresponding to the transmission interface, the index input device, the vibrator, the power supply device and the game machine main unit.

### BRIEF DESCRIPTION OF THE DRAWINGS

FIG. 1 is a system block diagram of a game control device according to the present invention.

FIG. 2 is a display picture changing operation flow chart according to the present invention.

FIG. 3 is a status display flow chart according to the present invention.

FIG. 4 is a schematic drawing showing the display of the status data of the index input device according to the present invention.

FIG. 5 is a schematic drawing showing the display of the status data of the vibrator according to the present invention.

FIG. 6 is a schematic drawing showing a game control device according to the prior art.

### DETAILED DESCRIPTION OF THE PREFERRED EMBODIMENT

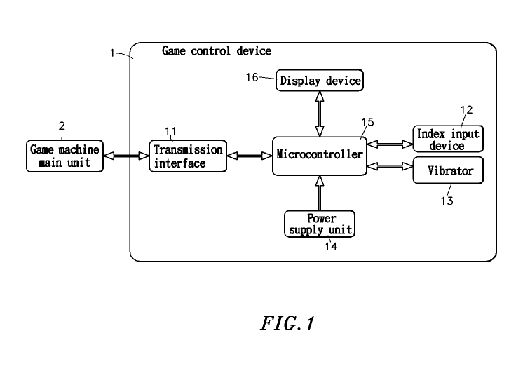

Referring to FIG. 1, a game control device 1 in accordance with the present invention is shown comprising a transmission interface 11, an index input device 12, a vibrator 13, a power supply unit 14, a microcontroller 15, and a display device 16.

The transmission interface 11 is for data transmission between the game control device 1 and a game machine main unit 2, and capable of producing a status signal during transmission of data. The game machine main unit 2 has audio output. The transmission interface 11 can be a wired transmission interface or wireless transmission interface. For wireless data transmission, the transmission interface 11 can be constructed subject to infrared, ZigBee, Bluetooth or Wi-Fi technologies. For wired data transmission, the transmission interface 11 can be an IEEE1394 (Institute of Electrical and Electronic Engineers Standard Bus Interface), USB (Universal Serial Bus), SATA (Serial Advanced Technology Attachment), IDE (Integrated Device Electronics), or SCSI (Small Computer Standard Interface).

The index input device 12 is a cursor control device made in the form of switch, button, joystick, crossed keyboard, force feedback, game pad, rockfire, directional button, or tablet for providing an index control signal.

The vibrator 13 can receive signal and produce a relative vibration upon receipt of a signal. During vibration, the vibrator produces a relative vibration strength signal. Further, the vibrator 13 can be formed of a motor.

The power supply unit 14 provides the game control device 1 with the necessary working power, and can produce a power status signal. The power supply unit 14 can be a battery pack.

The microcontroller 15 receives the status signal from the transmission interface 11 during data transmission, the control signal from the index input device 12 during working of the index input device 12, the vibration strength signal from the vibrator 13 during vibration of the vibrator 13, the power status signal from the power supply unit 14 and the status signal of the game machine main unit 2, and convert these signals into a status data for output to the display device 16.

The display device 16 receives and displays the status data from the microcontroller 15. The display device 16 can be a dot matrix type TFT-LCD (Thin Film Transistor-Liquid Crystal Display), TN-LCD (Twisted Nematic-Liquid Crystal Display), STN-LCD (Super Twisted Nematic-Liquid Crystal Display), PDP (Plasma Display), Color STN LCD (Color Super Twisted Nematic Liquid Crystal Display), Fast STN LCD (Fast Super Twisted Nematic Liquid Crystal Display), OLED (Organic Light-Emitting Diodes), LTPS LCD (Low Temperature Polycrystal Silicon Liquid Crystal Display), or related equivalent display means.

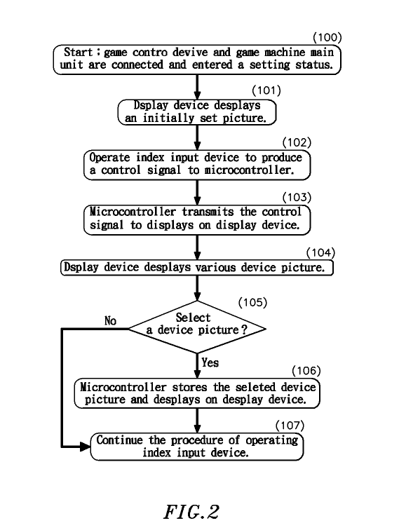

FIG. 2 is a display picture changing operation flow chart according to the present invention. Referring to FIGS. 1 and 2, when changing the display picture of the display device 16, the game control device 1 proceeds with the following steps.

(100) Start where the game control device 1 and the game machine main unit 2 are connected and entered a setting status.

(101) The display device 16 displays an initially set picture.

(102) Operate the index input device 12 to produce a control signal to the microcontroller 15.

(103) The microcontroller 15 transmits the control signal to the display device 16.

(104) The display device 16 displays various device pictures.

(105) Select a device picture? And then proceed to step (106) if positive or step (107) if negative.

(106) The microcontroller 15 stores the selected device picture and displays the selected device picture on the display device 16.

(107) Continue the procedure of operating the index input device 12 and return to step (102).

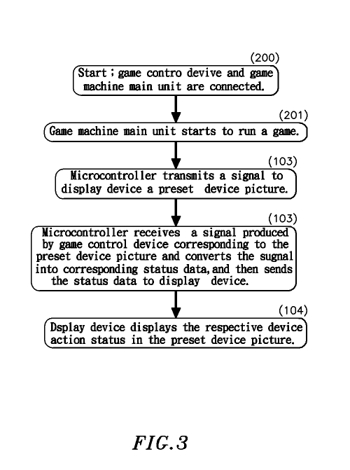

FIG. 3 is a status display flow chart according to the present invention. Referring to FIGS. 1 and 3, when displaying the status of the game control device 1, the game control device 1 proceeds with the following steps.

(200) Start where the game control device 1 and the game machine main unit 2 are connected.

(201) The game machine main unit 2 starts to run a game.

(202) The game control device 1 start to run.

(203) The microcontroller 15 transmits a signal to the display device 16, causing the display device 16 to display a preset device picture.

(204) The microcontroller 15 receives a signal produced by the game control device 1 corresponding to the preset device picture and converts the signal into corresponding status data, and then sends the status data to the display device 16.

(205) The display device 16 displays the respective device action status in the preset device picture.

As indicated above, when operating the game control device 1, the index input device 12 produces a control signal to drive the microcontroller 15 into a set status, and the display device 16 is controlled to display a set picture, and to show the device picture corresponding to the transmission interface 11, the index input device 12, the vibrator 13, the power supply device 14, and the game machine main unit 2. Thereafter, operate the index input device 12 to select a device picture to be displayed on the display device 16. After selection, withdraw from the setting status. After connection between the game control device 1 and the game machine main unit 2, the display device 16 displays the status of the selected device picture, for example, the status of the transmission interface 11. At this time, the microcontroller 15 receives the data transmission status signal from the transmission interface 11 and converts the data transmission status signal into a status data, and then sends the status data to the display device 16, causing the display device 16 to display the status data of the transmission interface 11 in the form of a figure, barcode or waveform.

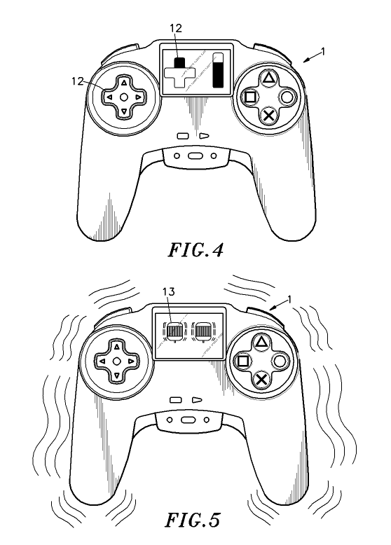

FIG. 4 is a schematic drawing showing the display of the status data of the index input device. When the display device 16 is controlled to display a device picture of the index input device 12, the microcontroller 15 receives a control signal produced by the index input device 12 and converts the control signal into corresponding status data, and then sends the status data to the display device 16, causing the display device 16 to display the status data of the index input device 12 in the form of a figure, barcode or waveform for review. The operator can compare the status data displayed on the display device 16 to the index input device 12, checking any possible failure of the index input device 12.

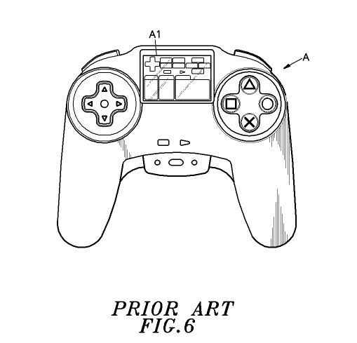

FIG. 5 is a schematic drawing showing the display of the status data of the vibrator. When the display device 16 is controlled to display a device picture of the vibrator 13, the microcontroller 15 receives a vibration strength signal produced by the vibrator 13 and converts the vibration strength signal into corresponding status data, and then sends the status data to the display device 16, causing the display device 16 to display the status data (vibration strength) of the vibrator 13 in the form of a figure, barcode or waveform for review.

When the display device 16 is controlled to display a device picture of the power supply device 14, the microcontroller 15 receives a power status signal produced by the power supply device 14 and converts the power status signal into corresponding status data, and then sends the status data to the display device 16, causing the display device 16 to display the status data (power status) of the power supply device 14 in the form of a figure, barcode or waveform, and to produce a warning signal when power low.

When the display device 16 is controlled to display a device picture of the game machine main unit 2, the microcontroller 15 receives an audio signal or time signal produced by the game machine main unit 2 and converts the signal into corresponding status data, and then sends the status data to the display device 16, causing the display device 16 to display the status data (voice strength) of the game machine main unit 2 or the game time or the current time in the form of a figure, barcode or waveform.

When compared to the prior art design, the invention has the following advantages.

(1) The display device 16 can display the operation status of the transmission interface 11, the index input device 12, the vibrator 13 or the power supply device 14. Each time using the game control device 1, the user can know if the current action of the transmission interface 11, the index input device 12, the vibrator 13 or the power supply device 14 is normal or not, and can immediately know the abnormal status when the transmission interface 11, the index input device 12, the vibrator 13 or the power supply device 14 failed. Therefore, the invention greatly extends the service life of the game control device 1.

(2) The display 1 can alternatively display the device pictures of the transmission interface 11, the index input device 12, the vibrator 13 and the power supply device 14. This design eliminates the problem of dividing the display picture into several display blocks.

Although particular embodiments of the invention have been described in detail for purposes of illustration, various modifications and enhancements may be made without departing from the spirit and scope of the invention.

What is claimed is:

1. A game control device for use with a game machine main unit having an audio output, the game control device comprising:
a transmission interface for data transmission between said game control device and said game machine main unit;
an index input device for providing an index control signal;
a vibrator for producing a vibration;
a power supply device for providing said game control device with the necessary working power;
display means for displaying data; and
a microcontroller electrically coupled to said transmission interface, said index input device, said vibrator, said power supply device and said display means;
wherein said transmission interface, said index input device, said vibrator and said power supply device respectively produce a respective status signal during operation; said
microcontroller receives said status signal from said transmission interface, said index input device, said vibrator, said power supply device and said game machine main unit, converts said status signal into a corresponding status data, and sends said status data to said display means; said display means is controlled by said microprocessor to display each status data received from said microprocessor in a respective device picture corresponding to said transmission interface, said index input device, said vibrator, said power supply device and said game machine main unit.

2. The game control device as claimed in claim 1, wherein said index input device produces a control signal to said microcontroller when operated; said microcontroller converts said control signal from said index input device into a corresponding status data and driving said display means to display a device picture corresponding to one of said transmission interface, said index input device, said vibrator, said power supply device and said game machine main unit subject to the nature of said control signal from said index input device.

3. The game control device as claimed in claim 1, wherein said microcontroller converts said status signal of said vibrator into a vibration strength data in one of the forms of figure, barcode and waveform for display through said display means.

4. The game control device as claimed in claim 1, wherein said microcontroller converts said status signal of said index input device into a status data in one of the forms of figure, barcode and waveform for display through said display means.

5. The game control device as claimed in claim 1, wherein said microcontroller converts said status signal of said power supply device into a power status data in one of the forms of figure, barcode and waveform for display through said display means.

6. The game control device as claimed in claim 1, wherein said display means is controllable by said microcontroller to produce a warning signal when said power status data shows a power lower status.

7. The game control device as claimed in claim 1, wherein said display means is controllable by said microcontroller to display the running time of the game being played and the current time.

8. The game control device as claimed in claim 1, wherein said microcontroller converts said status signal of said transmission interface into a data transmission strength status data in one of the forms of figure, barcode and waveform for display through said display means.

9. The game control device as claimed in claim 1, wherein said microcontroller converts said status signal of said game machine main unit into an audio signal strength status data in one of the forms of figure, barcode and waveform for display through said display means.

10. The game control device as claimed in claim 1, wherein said transmission interface is a wired transmission interface selected from one of the interfaces of IEEE1394 (Institute of Electrical and Electronic Engineers Standard Bus Interface), USB (Universal Serial Bus), SATA (Serial Advanced Technology Attachment), IDE (Integrated Device Electronics), and SCSI (Small Computer Standard Interface).

11. The game control device as claimed in claim 1, wherein said transmission interface is a wireless transmission interface constructed subject to one of infrared, ZigBee, Bluetooth and WiFi technologies.

12. The game control device as claimed in claim 1, wherein said index input device is made in one of the forms of switch, button, joystick, crossed keyboard, force feedback, game pad, rockfire, directional button, and tablet.

13. The game control device as claimed in claim 1, wherein said display means is selected from one of the displays of TFT-LCD (Thin Film Transistor-Liquid Crystal Display), TN-LCD (Twisted Nematic-Liquid Crystal Display), STN-LCD (Super Twisted Nematic-Liquid Crystal Display), PDP (Plasma Display, Color STN LCD (Color Super Twisted Nematic Liquid Crystal Display), Fast STN LCD (Fast Super Twisted Nematic Liquid Crystal Display), OLED (Organic Light-Emitting Diodes), and LTPS LCD (Low Temperature Polycrystal Silicon Liquid Crystal Display).

14. The game control device as claimed in claim 1, wherein said display means is a dot matrix display.
